(19) United States
(12) Patent Application Publication
(10) Pub. No.: US 2026/0018931 A1
(43) Pub. Date: Jan. 15, 2026

(54) INTERNAL AND EXTERNAL DEVICES CONTROL IN WIRELESS POWER SYSTEMS

(71) Applicant: Renesas Electronics America Inc., Milpitas, CA (US)

(72) Inventors: Gustavo James MEHAS, Fall City, WA (US); Filippo Maria NERI, Seefeldstrasse (CH); John Padraig HENNESSY, Seefeldstrasse (CH); Marco SAUTTO, Seefeldstrasse (CH)

(73) Assignee: Renesas Electronics America Inc., Milpitas, CA (US)

(21) Appl. No.: 18/771,202

(22) Filed: Jul. 12, 2024

(51) Int. Cl. H02J 50/12; H02J 50/80

(52) U.S. Cl. CPC H02J 50/12; H02J 50/80

(57) ABSTRACT

Systems and methods for wireless power transmission are described. A wireless power transmitter can include a coil, an analog front end (AFE) and a controller. The AFE can include a set of internal metal-oxide-semiconductor field-effect transistors (MOSFETs). The controller can be configured to generate a set of pulse width modulation (PWM) signals. The controller can be further configured to send the set of PWM signals to the AFE. At least one of the AFE and the controller can be configured to perform dead time optimization by using the PWM signals to control at least one of the set of internal MOSFETs and a set of external MOSFETs connected between the AFE and the coil. The coil can be driven by the set of internal MOSFETs and the set of external MOSFETs.

### BACKGROUND

The present disclosure relates in general to apparatuses and methods for communication between wireless power transmitters and wireless power receivers.

Wireless power systems often include a transmitter and a receiver having a receiver coil. When a transmission coil of the transmitter and the receiver coil of the receiver are positioned close to one another they form a transformer that facilitates inductive transmission of an alternating current (AC) power between the transmitter and the receiver. The receiver often includes a rectifier circuit that converts the AC power into a direct current (DC) power that may be utilized for various loads or components that require DC power to operate. The transmitter and the receiver also utilize the transformer to exchange information or messages using various modulation schemes. For example, the receiver may include a resonant circuit having one or more capacitors and may switch in or switch out a different number of capacitors of the resonant circuit to generate amplitude shift key (ASK) signals and encode messages in the ASK signals. The receiver can transmit the ASK signals to the transmitter to communicate with the transmitter via the transformer. The transmitter decodes the messages from the ASK signals received from the receiver and encodes response messages in frequency shift key (FSK) signals that may be transmitted back to the receiver via the transformer.

### SUMMARY

In one embodiment, an integrated circuit in a wireless power transmitter is generally described. The integrated circuit can include an analog front end (AFE) including a set of internal metal-oxide semiconductor field-effect transistors (MOSFETs). The integrated circuit can further include a controller configured to generate a set of pulse width modulation (PWM) signals. The controller can be further configured to send the set of PWM signals to the AFE. At least one of the AFE and the controller can be configured to perform dead time optimization by using the set of PWM signals to control the set of internal MOSFETs and a set of external MOSFETs connected to the AFE.

In one embodiment, a wireless power transmitter is generally described. The wireless power transmitter can include a coil, an analog front end (AFE) and a controller. The AFE can include a set of internal metal-oxide-semiconductor field-effect transistors (MOSFETs). The controller can be configured to generate a set of pulse width modulation (PWM) signals. The controller can be further configured to send the set of PWM signals to the AFE. At least one of the AFE and the controller can be configured to perform dead time optimization by using the PWM signals to control at least one of the set of internal MOSFETs and a set of external MOSFETs connected between the AFE and the coil. The coil can be driven by the set of internal MOSFETs and the set of external MOSFETs.

In one embodiment, a method for operating a wireless power transmitter is generally described. The method can include generating, by a controller of a wireless power transmitter, a set of pulse width modulation (PWM) signals. The method can further include sending, by the controller of the wireless power transmitter, the set of PWM signals to an analog front end (AFE) of the wireless power transmitter. The method can further include performing, by at least one of the AFE and the controller of the wireless power transmitter, dead time optimization by using the set of PWM signals to control a set of internal MOSFETs in the AFE and a set of external MOSFETs connected between the AFE and a coil.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a block diagram of an example system for implementing internal and external devices control in wireless power systems in one embodiment.

FIG. 2 is a circuit diagram illustrating an example transmitter for internal and external devices control in wireless power systems in one embodiment.

FIG. 3 is a diagram of example waveforms illustrating dead time optimization resulting from internal and external devices control in wireless power systems in one embodiment.

FIG. 4 is a circuit diagram illustrating an example implementation of an analog front end (AFE) of a transmitter for internal and external devices control in wireless power systems in one embodiment.

FIG. 5 is a diagram of example waveforms of the example implementation of the AFE shown in FIG. 4 in one embodiment.

FIG. 6 is a circuit diagram illustrating another example implementation of an analog front end (AFE) of a transmitter for internal and external devices control in wireless power systems in one embodiment.

FIG. 7 is a diagram of example waveforms of the example implementation of the AFE shown in FIG. 6 in one embodiment.

FIG. 8 is a diagram of example waveforms of the example implementation of the AFE shown in FIG. 4 in one embodiment.

FIG. 9 is a circuit diagram illustrating another example implementation of an analog front end (AFE) of a transmitter for internal and external devices control in wireless power systems in one embodiment.

FIG. 10 is a diagram of example waveforms of the example implementation of the AFE shown in FIG. 9 in one embodiment.

FIG. 11 is a flow diagram illustrating another process to implement internal and external devices control in wireless power systems in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

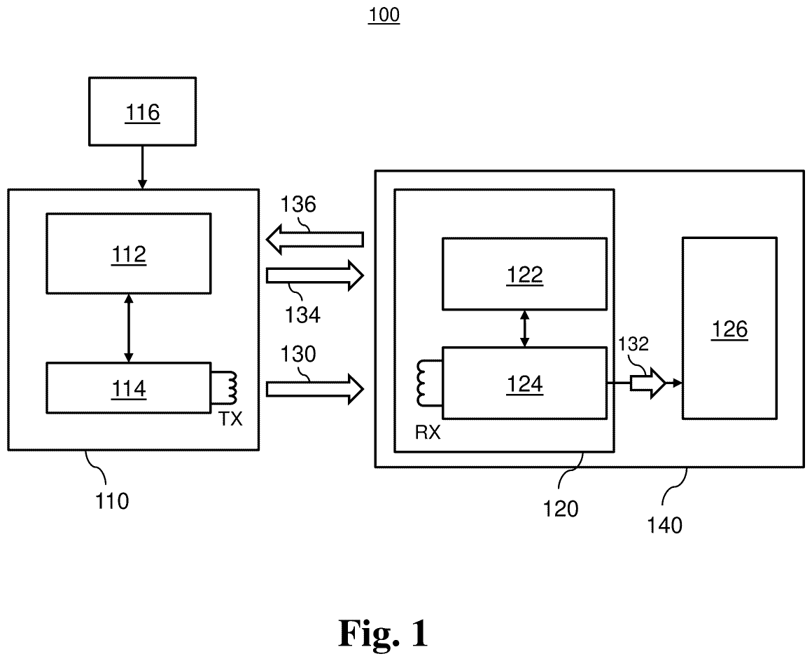

FIG. 1 is a block diagram of an example system for implementing internal and external devices control in wireless power systems in one embodiment. System 100 can include a transmitter 110 and a receiver 120 that are configured to wirelessly transfer power and data therebetween via inductive coupling. While described herein as transmitter 110 and receiver 120, each one of transmitter 110 and receiver 120 can be configured to both transmit and receive power or data therebetween via inductive coupling. Transmitter 110 can be configured to receive power from one or more power supplies, such as a power supply 116. Power supply 116 can be an alternating current (AC) power supply or a direct current (DC) power supply. Transmitter 110 can be configured to transmit AC power 130 to receiver 120 wirelessly.

Receiver 120 can be configured to receive AC power 130 transmitted from transmitter 110, convert the AC power 130 into DC power 132 and supply the DC power 132 to one or more loads, such as a load 126, or other components of a destination device 140. Destination device 140 can be, for example, a computing device, mobile device, mobile telephone, smart device, tablet, wearable device or any other electronic device that is configured to receive power wirelessly. In an illustrative embodiment, destination device 140 can include receiver 120. In other embodiments, receiver 120 can be separated from destination device 140 and connected to destination device 140 via a wire or other component that is configured to provide power to various components or loads of destination device 140.

Transmitter 110 can include at least a controller 112 and a power driver 114. Controller 112 can be configured to control and operate power driver 114. Controller 112 can include, for example, a processor, central processing unit (CPU), field-programmable gate array (FPGA) or any other circuitry that is configured to control and operate power driver 114. While described as a CPU in illustrative embodiments, controller 112 is not limited to a CPU in these embodiments and may comprise any other circuitry that is configured to control and operate power driver 114. In an example embodiment, controller 112 can be configured to control power driver 114 to drive a coil TX of the power driver 114 to produce a magnetic field. Power driver 114 is configured to drive coil TX at a range of frequencies and configurations defined by wireless power standards, such as, e.g., the Wireless Power Consortium (Qi) standard, the Power Matters Alliance (PMA) standard, the Alliance for Wireless Power (A for WP, or Rezence) standard or any other wireless power standards. The coil TX can be a part of a resonant circuit of the transmitter 110 for communicating with the receiver 120 at a specified resonant frequency.

Receiver 120 can include a controller 122 and a power rectifier 124. Controller 122 can include, for example, a processor, central processing unit (CPU), field-programmable gate array (FPGA) or any other circuitry that may be configured to control and operate power rectifier 124. Power rectifier 124 can include a coil RX and is configured to rectify power received via coil RX into a power type as needed for load 126. Power rectifier 124 can be configured to rectify AC power 130 received from coil RX into DC power 132 which may then be supplied to load 126. The coil RX can be a part of a resonant circuit of the receiver 120 for communicating with the transmitter 110 at the specified resonant frequency.

By way of example, when receiver 120 is placed in proximity to transmitter 110, the magnetic field produced by coil TX of power driver 114 induces a current in coil RX of power rectifier 124. The induced current causes AC power 130 to be inductively transmitted from power driver 114 to power rectifier 124. Power rectifier 124 receives AC power 130 and converts AC power 130 into DC power 132. DC power 132 is then provided by power rectifier 124 to load 126. In one or more embodiments, load 126 can be, for example, a battery charger that is configured to charge a battery of the destination device 140, a DC-DC converter that is configured to supply power to a processor, a display, or other electronic components of the destination device 140, or any other load of the destination device 140.

Transmitter 110 and receiver 120 can also be configured to exchange information or data, e.g., messages, via the inductive coupling of power driver 114 and power rectifier 124. For example, before transmitter 110 begins transferring power to receiver 120, a power contract may be agreed upon and created between receiver 120 and transmitter 110. For example, receiver 120 may send communication packets or other data to transmitter 110 that indicate power transfer information such as, e.g., an amount of power to be transferred to receiver 120, commands to increase, decrease, or maintain a power level of AC power 130, commands to stop a power transfer, or other power transfer information. In another example, in response to receiver 120 being brought in proximity to transmitter 110, e.g., close enough such that a transformer may be formed by coil TX and coil RX to facilitate power transfer, receiver 120 may be configured to initiate communication by sending a signal to transmitter 110 that requests a power transfer. In such a case, transmitter 110 may respond to the request by receiver 120 by establishing the power contract or beginning power transfer to receiver 120, e.g., if the power contract is already in place.

Transmitter 110 and receiver 120 can transmit and receive communication packets, data or other information via the inductive coupling of coil TX and coil RX. As an example, communication packet sent from transmitter 110 to receiver 120 may comprise frequency shift key (FSK) signals 134. FSK signals 134 are frequency modulated signals that represent digital data using variations in the frequency of a carrier wave. Communication packets sent from receiver 120 to transmitter 110 may comprise amplitude shift key (ASK) signals 136. ASK signals 136 are amplitude modulated signals that represent digital data using variations in the amplitude of a carrier wave. While transmitter 110 is described as sending FSK signals 134 and receiver 120 is described as sending ASK signals 136, in other embodiments, receiver 120 may alternatively send FSK signals and transmitter 110 may alternatively send ASK signals. Any other manner of transmitting communication packets, data or other information between transmitter 110 and receiver 120 may alternatively be used.

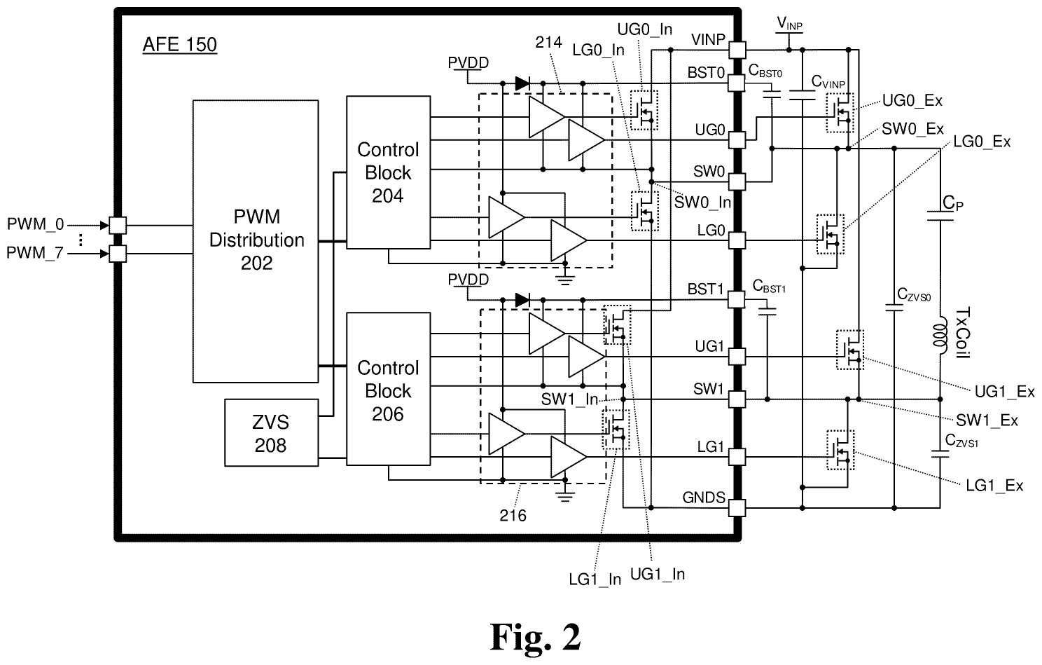

FIG. 2 is a circuit diagram illustrating an example transmitter for internal and external devices control in wireless power systems in one embodiment. Descriptions of FIG. 2 can reference components shown in FIG. 1. In an embodiment shown in FIG. 2, transmitter 110, controller 112 can be configured to communicate with an analog front-end (AFE) 150 of the power driver 114 using one or more signals such as, e.g., pulse-width modulation (PWM) signals labeled as PWM_0 to PWM_7 or other signals, to control and operate power driver 114 to provide power or data using coil TX. Controller 112 can be configured to supply any other number of PWM signals, such as one or more of PWM_0 to PWM_7, to AFE 150 for controlling and operating power driver 114. In one or more embodiments, the PWM signals may not be encoded by the controller 112 and may not be decoded by the AFE 150, but instead can be provided as-is to the AFE 150. In other embodiments, the PWM signals may alternatively be encoded by the controller 112 and decoded by the AFE 150.

AFE 150 can be configured to receive one or more of the PWM signals PWM_0 to PWM_7. AFE 150 can include a PWM distribution circuit 202 configured to route PWM signals PWM_0 to PWM_7 to one or more control blocks 204, 206. Each one of control blocks 204, 206 can be a driver controller circuit configured to convert PWM signals provided by PWM distribution circuit 202 into gate voltages for driving one or more switching devices, such as metal-oxide-semiconductor field-effect transistors (MOSFETs), that will be described in more detail below. In the embodiment shown in FIG. 2, control block 204 can provide one or more PWM signals to one or more drivers 214 (e.g., depicted as triangles inside drivers 214 in FIG. 2) and control block 206 can provide one or more PWM signals to one or more drivers 216 (e.g., depicted as triangles inside drivers 216 in FIG. 2). Drivers 214 can be configured to drive a top portion, or a top half, of MOSFETs in transmitter 110 and drivers 216 can be configured to drive a bottom portion, or a bottom half, of MOSFETs in transmitter 110. In one embodiment, transmitter 110 can operate in a half-bridge configuration where one of drivers 214, 216 (the top portion and the bottom portion) is activated. Transmitter 110 can operate in a full-bridge configuration where both drivers 214, 216 (both the top portion and the bottom portion) are activated. The embodiments shown herein include two internal MOSFETs and two external MOSFETs for each half bridge, but the control schemes described herein can be applicable to half bridge configurations that include two or more internal MOSFETs and two or more external MOSFETs.

Transmitter 110 can include one or more internal switching devices (e.g., MOSFETs) and one or more external switching devices (e.g., MOSFETs). An internal switching device can be a switching device that is internal to, or inside of, AFE 150. An external switching device can be a switching device that is external from, or outside of, AFE 150. In some embodiments, the external switching devices in 110 can be adjusted, such as being detached and replaced by different switching devices that may have the same or different MOSFET attributes and properties.

In the embodiment shown in FIG. 2, transmitter 110 can include a total of eight MOSFETs, including four internal MOSFETs in AFE 150 labeled as UG0_In, LG0_In, UG1_In and LG1_In and four external MOSFETs outside of AFE 150 labeled as UG0_Ex, LG0_Ex, UG1_Ex and LG1_Ex. The PWM signals PWM_0 to PWM_7 can be control signals for controlling the eight MOSFETs shown in FIG. 2. MOSFET UG0_In can be a high-side MOSFET connected between input voltage (e.g., VINP) and an internal switch node SW0_In. MOSFET UG1_In can be a high-side MOSFET connected between input voltage (e.g., VINP) and an internal switch node SW1_In. MOSFET LG0_In can be a low-side MOSFET connected between ground and internal switch node SW0_In. MOSFET LG1_In can be a low-side MOSFET connected between ground and internal switch node SW1_In. MOSFET UG0_Ex can be a high-side MOSFET connected between an output pin VINP and an external switch node SW0_Ex. MOSFET UG1_Ex can be a high-side MOSFET connected between the output pin VINP and an external switch node SW1_Ex. MOSFET LG0_Ex can be a low-side MOSFET connected between an output pin GNDS and external switch node SW0_Ex. MOSFET LG1_Ex can be a low-side MOSFET connected between the output pin GNDS and external switch node SW1_Ex.

The number of drivers in drivers 214 can be equivalent to the number of MOSFETs in the top portion and the number of drivers in drivers 216 can be equivalent to the number of MOSFETs in the bottom portion. In the embodiment shown in FIG. 2, drivers 214 can include four drivers for individually driving MOSFETs UG0_In, UG0_Ex, LG0_In and LG0_Ex. Drivers 216 can include four drivers for individually driving MOSFETs UG1_In, UG1_Ex, LG1_In and LG1_Ex. To drive one or more of the external MOSFETs, drivers 214 can output drive signals (e.g., in the form of gate voltages) for MOSFETs UG0_Ex, LG0_Ex, UG1_Ex and LG1_Ex via the output pins UG0, LG0, UG1 and LG1, respectively.

AFE 150 can include a BST0 output pin that connects PVDD to one side of a bootstrap capacitor CBST0. The other side of the bootstrap capacitor CBST0 can be connected to the output pin SW0. The bootstrap capacitor CBST0 can provide a floating voltage supply to power the gate drivers driving the high-side MOSFETs UG0_In and UG0_Ex such that these gate drivers can output gate voltages that is a sum of the voltage at SW0 and the floating voltage supply. AFE 150 can also include a BST1 output pin that connects PVDD to one side of a bootstrap capacitor CBST1. The other side of the bootstrap capacitor CBST1 can be connected to the output pin SW1. The bootstrap capacitor CBST1 can provide a floating voltage supply to power the gate drivers driving the high-side MOSFETs UG1_In and UG1_Ex such that these gate drivers can output gate voltages that is a sum of the voltage at SW1 and the floating voltage supply.

The high-side MOSFETs UG0_In and UG0_Ex in the top portion can be turned on (e.g., closed) and off (e.g., opened) individually, and can be turned on and turned off simultaneously. When UG0_In is turned on and UG0_Ex is turned off, the switch node output SW0 is driven by internal switch node SW0_In. When UG0_In is turned off and UG0_Ex is turned on, the switch node output SW0 is driven by external switch node SW0_Ex. When both UG0_In and UG0_Ex are turned on, the switch node output SW0 is driven by both SW0_In and SW0_Ex. The low-side MOSFETs LG0_In and LG0_Ex in the top portion can be turned on and off individually, and can be turned on and turned off simultaneously. The high-side MOSFETs (e.g., UG0_In, UG0_Ex) and the low-side MOSFETs (e.g., LG0_In, LG0_Ex) in the top portion can be turned off simultaneously but cannot be turned on simultaneously under normal operating conditions (e.g., while switching the internal and external MOSFETs to perform power conversion and power transfer). The high-side MOSFETs and the low-side MOSFETs in the top portion can be turned on simultaneously in special circumstances such as during calibration and various testing operations.

The high-side MOSFETs UG1_In and UG1_Ex in the bottom portion can be turned on and off individually, and can be turned on and turned off simultaneously. When UG1_In is turned on and UG1_Ex is turned off, the switch node output SW1 is driven by internal switch node SW1_In. When UG1_In is turned off and UG1_Ex is turned on, the switch node output SW1 is driven by external switch node SW1_Ex. When both UG1_In and UG1_Ex are turned on, the switch node output SW1 is driven by both SW1_In and SW1_Ex. The low-side MOSFETs LG1_In and LG1_Ex in the bottom portion can be turned on and off individually, and can be turned on and turned off simultaneously. The high-side MOSFETs (e.g., UG1_In, UG1_Ex) and the low-side MOSFETs (e.g., LG1_In, LG1_Ex) in the bottom portion can be turned off simultaneously but cannot be turned on simultaneously under normal operating conditions (e.g., while switching the internal and external MOSFETs to perform power conversion and power transfer). The high-side MOSFETs and the low-side MOSFETs in the bottom portion can be turned on simultaneously in special circumstances such as during calibration and various testing operations.

The coil TX can be driven to generate a magnetic field according to one or more of the PWM signals PWM_0 to PWM_7 received by AFE 150. The states (e.g., high and low) of the PWM signal PMW_0 to PWM_7 can control the states of the eight MOSFETs and the signals at output pins SW0, SW1. The PWM signals can control the MOSFETs such that the signals at switch node output pins SW0 and SW1 can be complementary. For example, the signal at SW0 can have a high voltage when the signal at SW1 is at low voltage, and the signal at SW0 can have a low voltage when the signal at SW1 is at high voltage.

AFE 150 can further include a zero voltage switching (ZVS) circuit 208. Control blocks 204, 206 can receive signals from ZVS circuit 208 and based on the received signals, determine whether to delay the rising edges of corresponding drive signals or gate voltages for driving the internal and external MOSFETs. The amount of delay of the rising edges (e.g., dead time delay) can optimize the dead time (e.g., when all MOSFETs are turned off) of the internal and external MOSFETs. ZVS circuit 208 can be configured to monitor feedback from switch nodes SW0 and SW1 and can notify control blocks 204, 206 whether the signals at the switch nodes are high, low or transitioning. ZVS circuit 208 can implement servo feed-back loop that detects situations where voltages of switch nodes SW0, SW1 fall within a region between the final voltage and the voltage clamped by the body diodes of the MOSFETs. In some embodiments, ZVS circuit 208 can include a comparator threshold that is monitored for the switch node outputs on each rising edge.

Conventional wireless power transmitters typically utilize only internal MOSFETs or only external MOSFETs. Transmitter 110 in the present disclosure includes both internal and external MOSFETs as shown in FIG. 2 (and in other Figures). Utilizing both internal and external MOSFETs in transmitter 110 can allow certain applications to have a lower overall turned-on drain-source resistance (RDSON) due to the addition of the external MOSEFTs, which can increase system efficiency without changing core components of transmitter 110. In an aspect, the internal MOSFETs can have similar turn on/turn off characteristics and the external MOSFETs can have similar turn on/turn off characteristics as well, but different from those of the internal MOSFETs. The different characteristics between the internal and external MOSFETs can result in different operation parameters. For example, the internal MOSFETs can be turned on relatively faster than the external MOSFETs. Therefore, there is a need to manage the timing and control of the internal and external MOSFETs to maximize performance of transmitter 110.

In some conventional systems, PWM signals can be used for controlling the internal MOSFETs or the external MOSFETs, but not both the internal and external MOSFETs. Offset can be added between different PWM signals and the MOSFETs (all internal or all external) can be driven directly with timings experimentally derived to achieve optimal performance. However, the performance can be optimized for a limited number of operating conditions and other operating conditions may have sub-optimal performance. Some other conventional systems include using an internal monitoring block to measure the switching characteristics of the switch nodes and modify the PWM dead time to align with a specific characteristic associated with optimal performance. Further, for systems that include more than two MOSFETs, such as having four internal MOSFETs or four external MOSFETs, at least two sets of PWM signals may be needed to control the MOSFETs. The control using at least two sets of PWM signals can have the PWM signals being phase shifted to modulate power, which provides half-bridge to half-bridge control of the internal MOSFETs or external MOSFETs. However, it may be challenging to use similar half-bridge to half-bridge control on transmitters having both internal and external MOSFETs, since each half bridge (e.g., top portion and bottom portion) includes both internal and external MOSFETs as shown in FIG. 2.

To be described herein, one or more of controller 112 and AFE 150 in power driver 114 of transmitter 110 can be configured to perform different control schemes to control both the internal and external MOSFETs of transmitter 110 to achieve optimized performance. In a first control scheme, AFE 150 can use programmable delay(s) and/or ON time to turn on the external MOSFETs after the internal MOSFETs are turned on, and turn off the external MOSFETs before the internal MOSFETs are turned off. In a second control scheme, the AFE can use additional PWM signals provided by controller 112 to control the external MOSFETs in such a way that they do not interfere with the internal MOSFETs operations. In a third control scheme, controller 112 can provide a PWM signal and AFE 150 can use the PWM signal to operate the internal MOSFETs. Based on operation of the internal MOSFETs, AFE 150 can determine whether to dither, or to determine an amount of dithering the internal and external MOSFET delays, to correlates changes in the switch node characteristics with dithering patterns for optimization. In a fourth control scheme, controller 112 can provide up to eight PWM signals to operate the internal and external MOSFETs to optimize dead time.

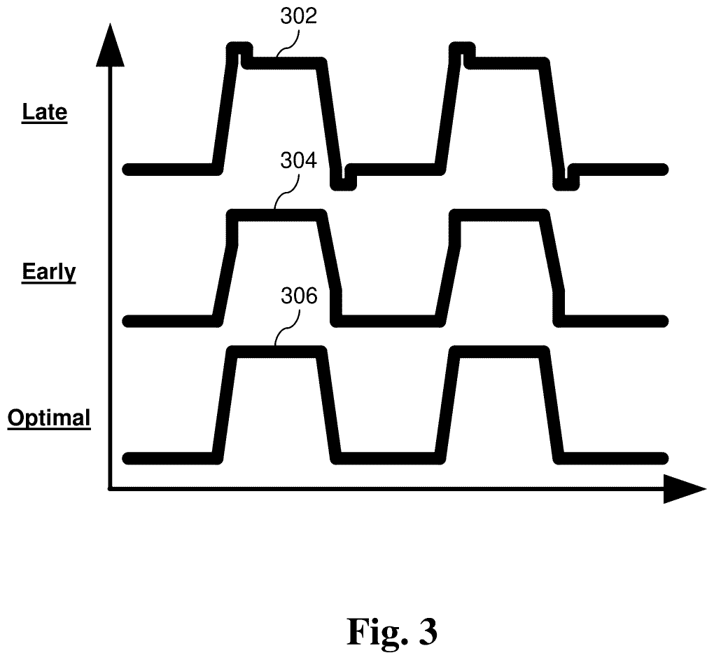

FIG. 3 is a diagram of example waveforms illustrating dead time optimization resulting from internal and external devices control in wireless power systems in one embodiment. Descriptions of FIG. 3 can reference components shown in FIG. 1 and FIG. 2. Among the example waveforms in FIG. 3, a waveform 302 represent a signal at a switch node where dead time (e.g., where all MOSFETs driving the switch node are turned off) of the MOEFETs driving the switch node are too long. As a result of the long dead time, the MOSFETs are being switched on late and the body diodes of the MOSFETs will conduct, causing power loss, and hard switching as large as the input voltage can occur. A waveform 304 can represent a signal at a switch node where dead time of the MOEFETs driving the switch node are too long. As a result of the long dead time, the MOSFETs are being switched on late and the signal at the switch node can undergo hard switching that is limited to the body diode voltage of the MOSFETs. A waveform 306 can represent a signal at a switch node where dead time of the MOEFETs driving the switch node is optimized by the control schemes described herein. When the deadtime is optimized, the MOSFETs are being switched at optimal times and the signal at the switch node has a smoother transition when compared to waveforms 302, 304.

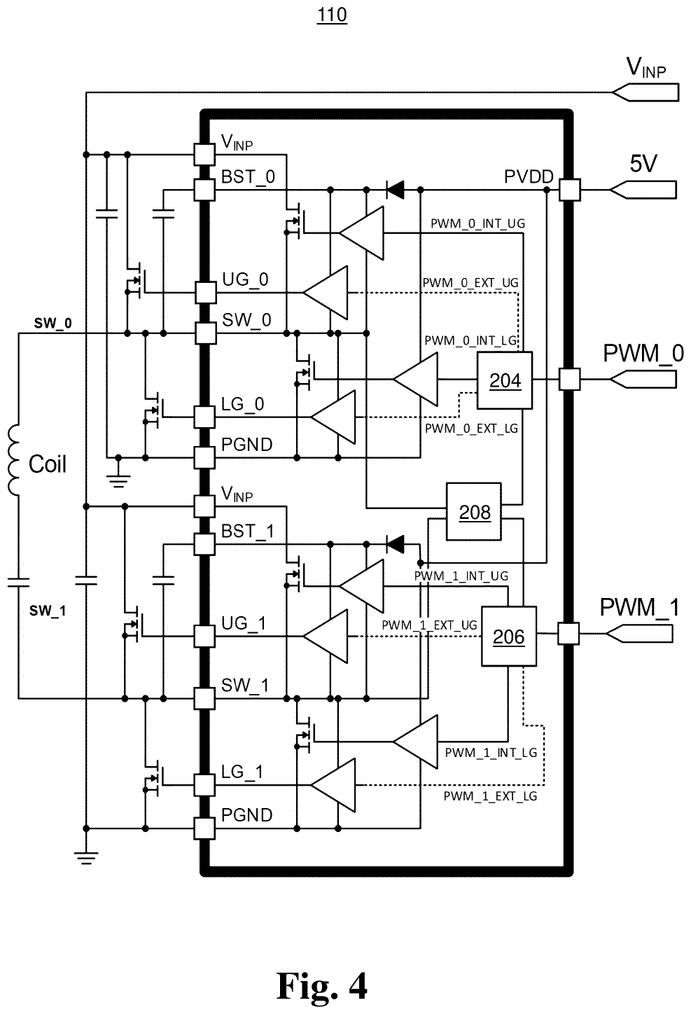

FIG. 4 is a circuit diagram illustrating an example implementation of an analog front end (AFE) of a transmitter for internal and external devices control in wireless power systems in one embodiment. Descriptions of FIG. 4 can reference components shown in FIG. 1 to FIG. 3. FIG. 4 shows an example embodiment of the first control scheme. Under the first control scheme, AFE 150 can use one or more programmable delay(s) and/or ON time to turn on the external MOSFETs after the internal MOSFETs are turned on, and to turn off the external MOSFETs before the internal MOSFETs are turned off. In the embodiment shown in FIG. 4, AFE 150 can receive two PWM signals, PWM_0 and PWM_1, from controller 112. ZVS circuit 208 can adjust the dead time delay of the internal MOSFETs such that the signal at the switch nodes SW0, SW1 have the optimal conditions (e.g., waveform 306 in FIG. 3). The external MOSFETs turn on can be set via a delay factor that is intended to ensure the external MOSFETs always turn on after the internal MOSFETs. In an aspect, the external MOSETs tend to turn on slower than the internal MOSFETs due to their different MOSFET characteristics, but for some corner conditions, such as using external MOSFETs with very low gate-source voltage (VGS) or turn on voltages, a delay may be required to ensure that the internal MOSFETs are controlling the switch node outputs.

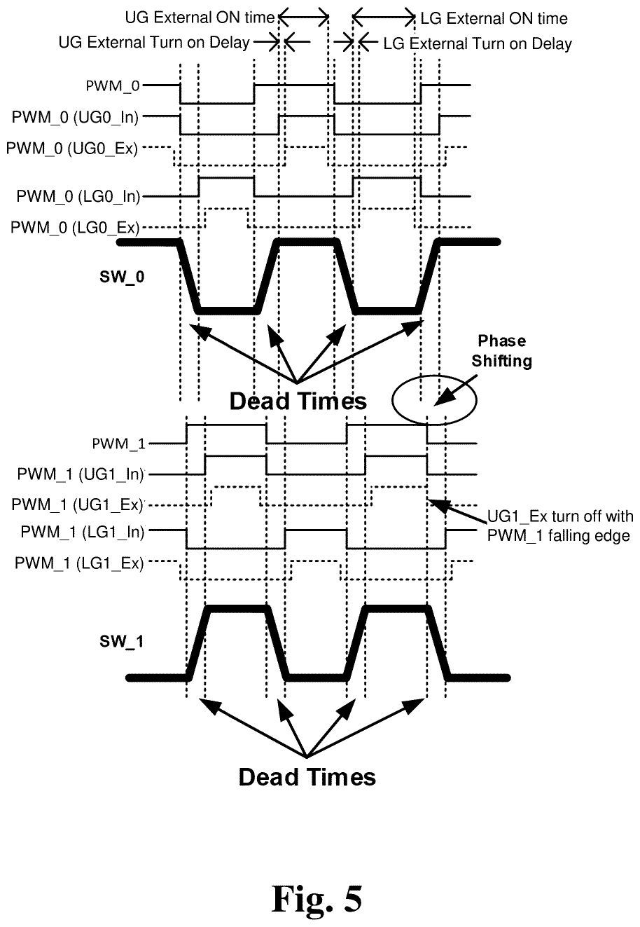

In an aspect, challenges may arise in controlling the external MOSFETs turn off because the switch node voltages are fed back to the controller 112 instead of AFE 150, which cause the turn off time to be unknown to AFE 150. To address this challenge, in one embodiment, AFE 150 can be configured to apply a fixed and programmable ON time which turns off the external MOSFETs at a fixed time. This fixed ON time can be set at a time that is before the PWM signal (e.g., PWM_0 and PWM_1) falling edge. In one embodiment, this fixed time can be programmable by user input (e.g., by user of system 100) and AFE 150 can receive digital data encoding this programmable fixed time. In one or more embodiments, AFE 150 can modify the fixed time in real-time based upon system variables such as temperature and initial delays. Waveforms resulting from an example implementation of this fixed ON time embodiment are shown in FIG. 5 (described below).

In one embodiment, AFE 150 can use two fixed and programmable delay variables. The first fixed delay can delay the external MOSFETs turn on with respect to the internal MOSFET turn on signal (e.g., turn on the external MOSFETs after turning on the internal MOSFETs). The second fixed delay can control turn off of the internal MOSFETs such that the external MOSFETs turn off at the falling edge of the PWM signals before turning off the internal MOSFETs.

The embodiment where AFE 150 uses one fixed ON time may lower an efficiency of transmitter 110 and the embodiment where AFE 150 uses the two fixed delays can add an additional phase shift between the input PWM signals PWM_0 and PWM_1 and the switch nodes SW0 and SW1, respectively, which may cause frequency instability. However, both embodiments can achieve optimal dead time. Therefore, the utilization of either one of the fixed delay embodiments under the first control scheme can be dependent on whether it is desirable to optimize efficiency or frequency stability.

FIG. 5 is a diagram of example waveforms of the example implementation of the AFE shown in FIG. 4 in one embodiment. Description of FIG. 5 can reference components shown in FIG. 1 to FIG. 4. The example waveforms in FIG. 5 illustrate the PWM signals PWM_0 and PWM_1 for controlling the internal and external MOSFETs to drive the voltages at switch nodes SW0 and SW1, respectively, under the first control scheme. The PWM_0 signal can be used for driving internal MOSFETs UG0_In, LG0_In and external MOSFETs UG0_Ex, LG0_Ex to control the voltage at switch node SW0 (labeled as SW_0 in FIG. 5).

Focusing on SW0, a UG external turn on delay can be applied by AFE 150 to delay the rising edge of UG0_Ex in order to ensure that the turn on time of UG0_Ex does not interfere with the auto ZVS function of ZVS circuit 208. A LG external turn on delay can be applied by AFE 150 to delay the rising edge of LG0_Ex in order to ensure that the turn on time of LG0_Ex does not interfere with the auto ZVS function of ZVS circuit 208. While the ON time duration of the external MOSFETs UG0_Ex and LG0_Ex are fixed, the ZVS circuit 208 and the PWM_0 signal can control the internal MOSFETs UG0_In and LG0_In by controlling the dead times during switching of the internal MOSFETs. In one embodiment, the fixed ON time can be reduced by the turn on delay applied to the external MOSFETs (e.g., ON time=fixed ON time-turn on delay). In another example, the fixed ON time can be triggered at the end of the turn on delay event. As a result of using the turn on delay, the external MOSFET UG0_Ex turns on after the internal MOSFET UG0_In and the external MOSFET LG0_Ex turns on after the internal MOSFET LG0_In. Also, the turn on delay in combination with the fixed ON time can ensure that the external MOSFET UG0_Ex turns off before the internal MOSFET UG0_In and the external MOSFET LG0_Ex turns off before the internal MOSFET LG0_In The UG external turn on delay and the LG external turn on delay can be dependent on the fixed ON time duration programmed for the external MOSFETs. By way of example, the fixed ON time is programmed to a fixed value, AFE can determine the turn on delay based on the fixed value, then ZVS circuit 208 can adjust the dead time to control the internal MOSFETs such that the voltage at SW0 has optimal dead time.

Focusing on SW1, similar delays can be applied as in SW0 to turn on UG1_Ex before UG1_In and to turn on LG1_Ex before LG1_In. In an example shown in FIG. 5, a phase shift created by the PWM signals PWM_0 and PWM_1 can cause UG1_Ex to turn off with the falling edge of PWM_1. By way of example, if controller 112 changes the PWM signals' pulse widths unexpectedly, the external MOSFET UG1_Ex can be forced to turn off such that the falling edge of PWM_1 overrides the fixed ON time, hence the external MOSFET is not being turned off after turning off the corresponding internal MOSFET. The phase shifting shown in FIG. 5 can be an example of the utilization of two fixed delays being applied by AFE 150 as described above. By way of example, the first fixed delay can delay the turn on time of an external MOSFET, then the second fixed delay can cause the external MOSFET to turn off at the falling edge of the PWM signal, then ZVS circuit 208 can adjust the dead time to control the internal MOSFETs such that the voltage at SW1 has optimal dead time.

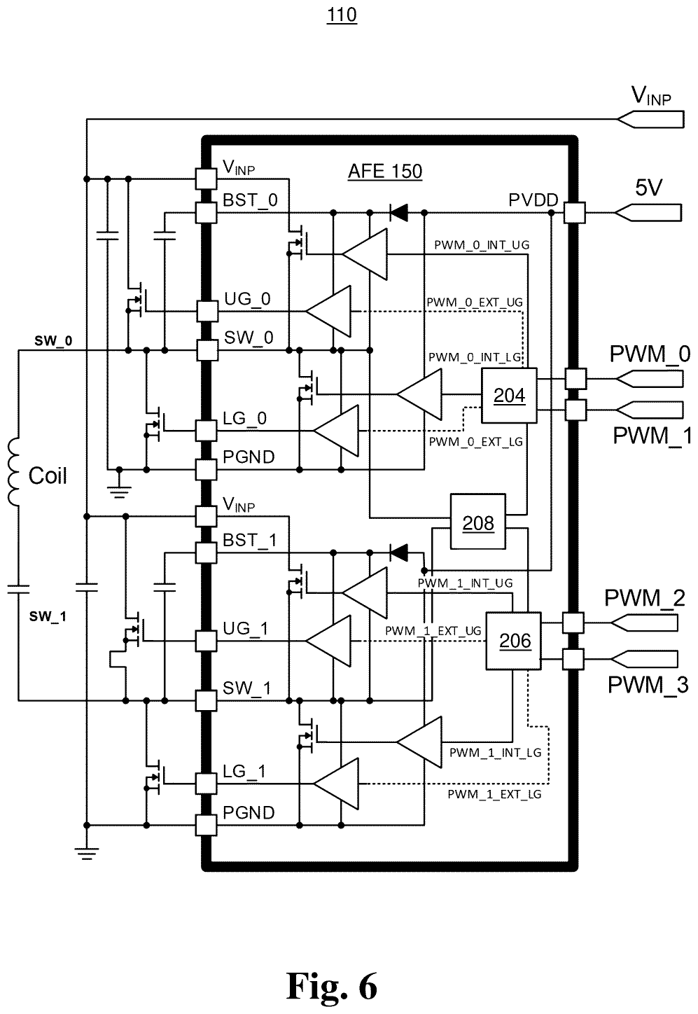

FIG. 6 is a circuit diagram illustrating another example implementation of an analog front end (AFE) of a transmitter for internal and external devices control in wireless power systems in one embodiment. Description of FIG. 6 can reference components shown in FIG. 1 to FIG. 5. In an aspect, the first control scheme can utilize additional hardware in AFE 150 such as an on time counter and a high resolution clock, both of which occupy silicon area and can generate heat. As an alternative to the first control scheme, the second control scheme relies on controller 112 to provide additional PWM signals to control AFE 150 for operating the internal and external MOSFETs. Under the second control scheme, AFE 150 can turn on and off the external MOSFETs according to PWM signals from controller 112 to avoid interference with the operation of ZVS circuit 208 for controlling the internal MOSFETs. In brief, the first control scheme described above utilizes the AFE 150 for determining fixed ON times and/or delays to control both the internal MOSFETs and the external MOSFETs, whereas the second control scheme in FIG. 6 utilizes the controller 112 to provide PWM signals to AFE 150 to allow AFE 150 to control the internal and external MOSFETs.

Each internal MOSFET pair in each bridge, such as a first pair of UG0_In and LG0_In and a second pair of UG1_In and LG1_In, can be controlled with a single PWM signal and ZVS circuit 208. In an aspect, each external MOSFET pair in each bridge, such as a first pair of UG0_Ex and LG0_Ex and a second pair of UG1_Ex and LG1_Ex, may require two separate PWMs to control the delays associated with the UG and LG external MOSFETs. For the transmitter 110 described herein, since the pairs of high-side and low-side external MOSFETs are never turned on at the same time, their control signals can be superimposed into a single PWM that operates at two times the fundamental switching frequency, which allows control of four MOSFETs using two PWM signals. In the example shown in FIG. 6, AFE 150 can receive four PWM signals PWM_0, PWM_1, PWM_2, PWM_3. PWM signal PWM_0 can be used for controlling the internal MOSFET UG0_In and the external UG0_Ex. PWM signal PWM_1 can be used for controlling the internal MOSFET LG0_In and the external LG0_Ex. PWM signal PWM_2 can be used for controlling the internal MOSFET UG1_In and the external UG1_Ex. PWM signal PWM_3 can be used for controlling the internal MOSFET LG1_In and the external LG1_Ex.

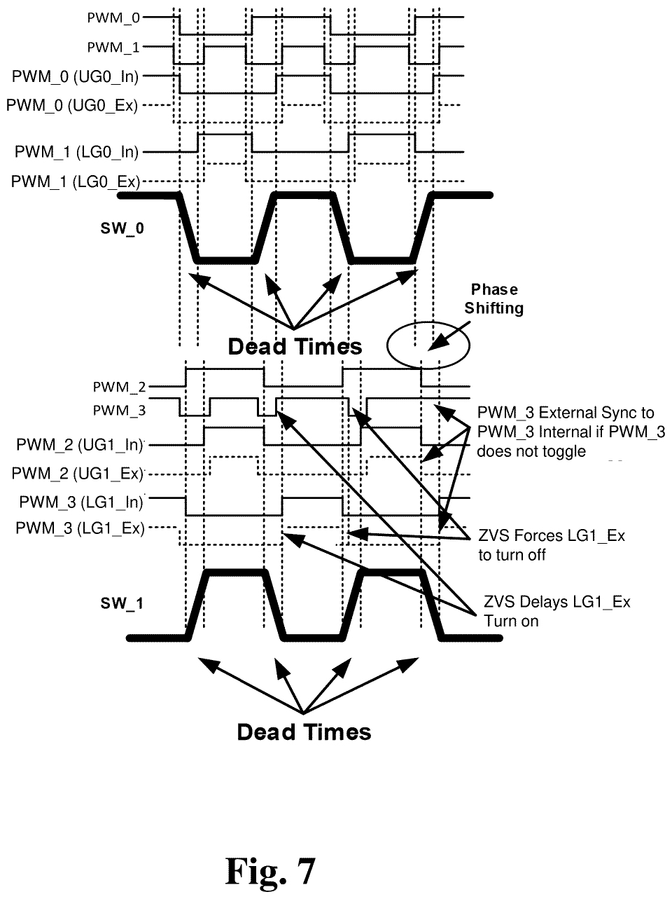

FIG. 7 is a diagram of example waveforms of the example implementation of the AFE shown in FIG. 6 in one embodiment. Description of FIG. 7 can reference components shown in FIG. 1 to FIG. 6. The example waveforms in FIG. 7 illustrate the PWM signals PWM_0, PWM_1, PWM_2 and PWM_3 for controlling the internal and external MOSFETs to drive the voltages at switch nodes SW0 and SW1, respectively, under the second control scheme. Focusing on SW0, the high-side MOSFETs UG0_In and UG0_Ex in the top portion are controlled by PWM_0. The low-side MOSFETs LG0_In and LG0_Ex in the top portion are controlled by PWM_1. Focusing on SW0, the high-side MOSFETs UG1_In and UG1_Ex in the bottom portion are controlled by PWM_2. The low-side MOSFETs LG1_In and LG1_Ex in the bottom portion are controlled by PWM_3.

In addition to the controlling the internal and external MOSFETs, the PWM signals provided by controller 112 can optimize the dead times between the high-side and low-side MOSFETs to avoid body diode conduction and hard switching. To optimize dead time, the PWM signals being provided by controller 112 can control the internal and external MOSFETs such that the external MOSFETs are turned on after the internal MOSFETs are turned on, and the external MOSFETs are turned off before the internal MOSFETs are turned off. Also, phase shifting can be performed, as shown in FIG. 7, to cause the external MOSFETs to turn off at the falling edge of the corresponding PWM signals. Further, to optimize dead time, the PWM signals provided by controller 112 can delay the turn on time of external MOSFETs and force the external MOSFETs to turn off. As shown in FIG. 7, LG1_Ex can be forced to turn off at the falling edge of PWM_3, and the turn on time of LG1_Ex can be delayed such that LG1_Ex turns on at the same time, or later than, the corresponding internal MOSFET LG1_In.

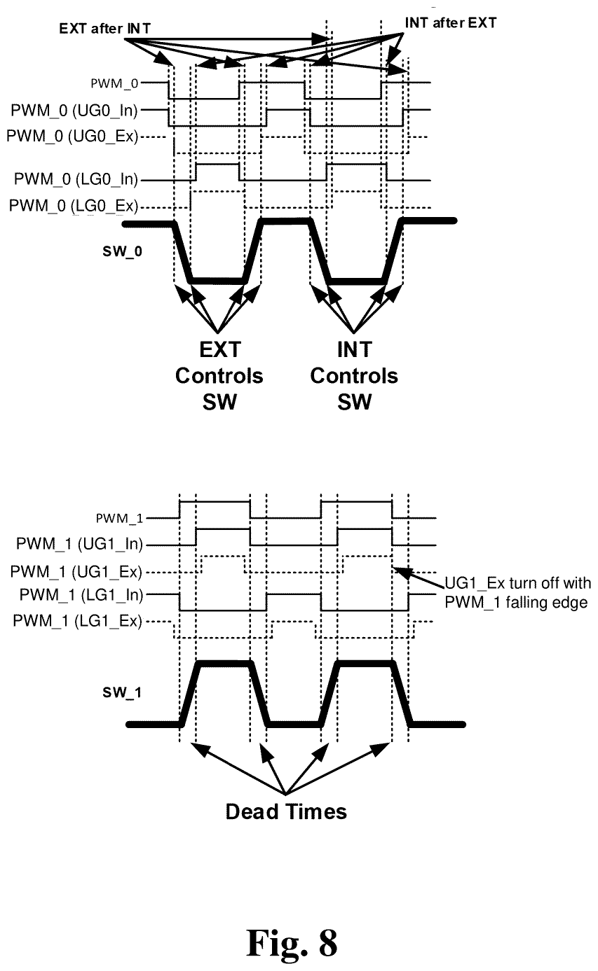

FIG. 8 is a diagram of example waveforms of the example implementation of the AFE shown in FIG. 4 in one embodiment. Description of FIG. 8 can reference components shown in FIG. 1 to FIG. 7. Using FIG. 4 as an example, the example waveforms in FIG. 8 illustrate the PWM signals PWM_0, PWM_1 for controlling the internal and external MOSFETs to drive the voltages at switch nodes SW0 and SW1, respectively, under the third control scheme. In the first and second control schemes mentioned above, the ZVS circuit 208 can dither the internal MOSFETs to optimize dead time while the external MOSFETs are controlled using fixed variables or PWM signals. In the third control scheme, the ZVS circuit 208 can apply dithering on one or more of the internal and external MOSFETs.

In one embodiment, controller 112 can provide PWM_0 to the top portion and PWM_1 to the bottom portion. AFE 150 can use PWM_0 to operate the internal MOSFETs UG0_In and LG0_In in the top portion, and can use PWM_1 to operate the internal MOSFETs UG1_In and LG1_In in the bottom portion. While AFE 150 operate the internal MOSFETs using the PWM signals, the external MOSFETs may be disabled. When only the internal MOSFETs are being operated by AFE 150, AFE 150 can determine various characteristics of the internal MOSFETs. By way of example, a characteristic that can be determined by AFE 150 can be the PWM delay between receipt times of the PWM signals from controller 112 and arrival times of the PWM signals at the internal MOSFETs. Also, AFE 150 can determine the dead time being set by ZVS circuit 208. Using the PWM delay and the dead time, AFE 150 can start operating the external MOSFETs and determine performance differences between operating the internal MOSFETs only versus operating both the internal and external MOSFETs. AFE 150 can use performance differences to determine whether to dither the external MOSFETs, or how much to dither the external MOSFETs, in order to optimize the dead time for the voltage at the switch nodes SW0 and SW1.

In the example waveforms shown in FIG. 8, dithering can be performed on both the internal and external MOSFETs after determination of various characteristics of the internal and external MOSFETs. As shown in FIG. 8, in a portion where the switch node SW0 is being driven or controlled by the external MOSFETs, the high-side external MOSFET UG0_Ex turns off at the same time as the high-side internal MOSFET UG0_In and turned on later than the high-side internal MOSFET UG0_In. Also, the low-side external MOSFET LG0_Ex turns on before the low-side internal MOSFET LG0_In and turned off later than the low-side internal MOSFET LG0_In.

Similarly in a portion where the switch node SW0 is being driven or controlled by the internal MOSFETs, the high-side external MOSFET UG0_Ex turns off before the high-side internal MOSFET UG0_In and turns on later than the high-side internal MOSFET UG0_In. Also, the low-side external MOSFET LG0_Ex turns on later than the low-side internal MOSFET LG0_In and turned off before the low-side internal MOSFET LG0_In. The behavior in the portion where SW0 is controlled by the internal MOSFETs is different from the portion where SW0 is controlled by the external MOSFETs. This different behavior is based on the adaptive dithering being performed by AFE 150, and the dithering can be applied on both the internal and external MOSFETs. Overall, the behavior of the third control scheme is different from the first and second control schemes where the external MOSFETs are turned on later than the internal MOSFETs and turn off before the internal MOSFETs. Despite the different behavior in the third control scheme, the dead time of the switch node SW0 is still optimized as a result of the different dithering on the internal and external MOSFETs. The dithering can allow both internal and external MOSFETs to be turned on at the same time to compensate for the different delays in a synchronized manner such that ZVS optimizations can also be achieved. Therefore, the dithering can lead to maximum efficiency for systems having both internal and external MOSFETs.

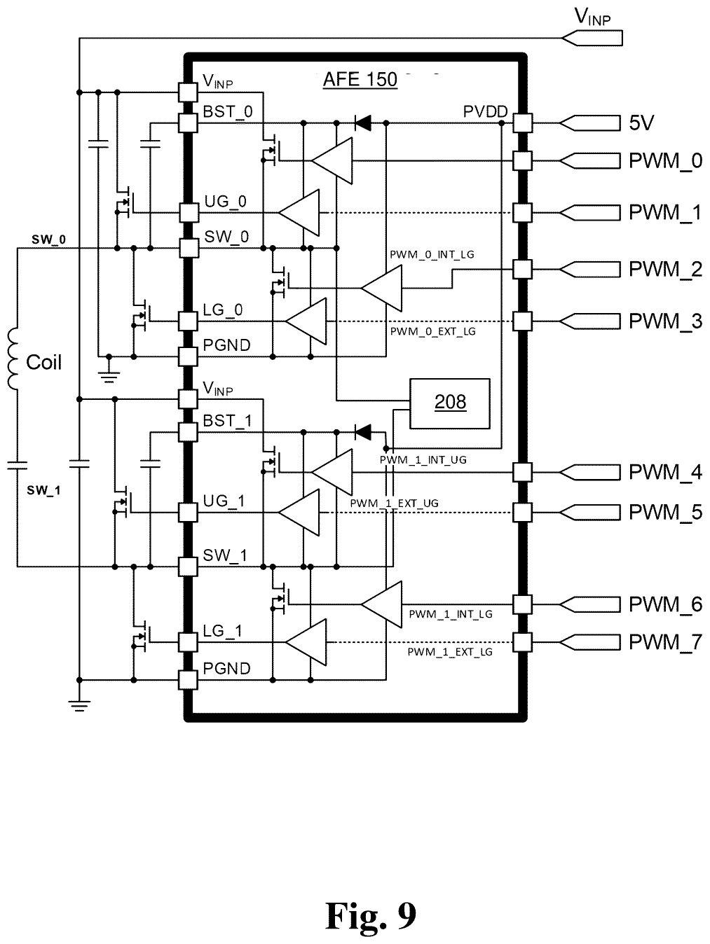

FIG. 9 is a circuit diagram illustrating another example implementation of an analog front end (AFE) of a transmitter for internal and external devices control in wireless power systems in one embodiment. Description of FIG. 9 can reference components shown in FIG. 1 to FIG. 8. FIG. 9 shows an example embodiment of the fourth control scheme. Under the fourth control scheme, controller 112 can provide up to eight PWM signals to operate the internal and external MOSFETs to optimize dead time, without using AFE 150 to control the MOSFETs. Comparing to the third control scheme, the fourth control scheme utilizes the controller 112 to operate the internal and external MOSFETs such that AFE 150 can preserve integrated circuit (IC) space and power. In one embodiment, under the fourth control scheme, AFE 150 can function as a driver with switch node state monitoring for transmitter 110. In the fourth control scheme, controller 112 can perform the dithering on the internal and external MOSFETs similar to the third control scheme. Controller 112 can determine the conditions and amount of dithering by monitoring the outputs of the switch nodes and ZVS circuit 208 in AFE 150. Controller 112 can modify the turn on and turn off times of the external MOSFETs based on the monitored outputs. In brief, under the fourth control scheme, controller 112 can perform the functions of AFE 150 under the first, second and third control schemes by providing eight PWM signals to drive eight MOSFETs.

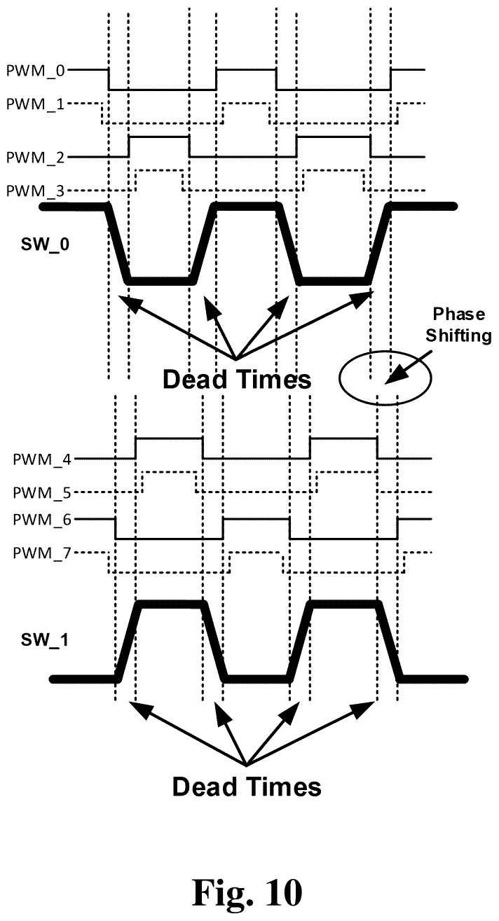

FIG. 10 is a diagram of example waveforms of the example implementation of the AFE shown in FIG. 9 in one embodiment. Description of FIG. 10 can reference components shown in FIG. 1 to FIG. 9. The example waveforms in FIG. 10 illustrate the PWM signals PWM_0 to PWM_7 for controlling the internal and external MOSFETs to drive the voltages at switch nodes SW0 and SW1, respectively, under the fourth control scheme. PWM_0, PWM_1, PWM_2, PWM_3 can drive UG0_In, UG0_Ex, LG0_In, LG0_Ex, respectively, to control the voltage at SW0. PWM_4, PWM_5, PWM_6, PWM_7 can drive UG1_In, UG1_Ex, LG1_In, LG1_Ex, respectively, to control the voltage at SW0. In the example shown in FIG. 10, the PWM signals can individually control the internal and external MOSFETs to achieve optimal dead time at switch nodes SW0, SW1.

In the embodiments described herein, once the characteristics of either the internal or external MOSFETs are known, the controller 112 and/or the AFE 150 can make adjustments to the other set of MOSFETs with unknown characteristics. For example, in the first and second control schemes, the fixed ON times and/or delays can be known information of the external MOSFETs, and the ZVS circuit 208 can then perform dead time optimization on the internal MOSFETs to achieve overall dead time optimization for transmitter 110. In the third and fourth control schemes, trial operations can be run on the internal MOSFETs to obtain known information of the internal MOSFETs, then dithering can be performed on the external MOSFETs to achieve dead time optimization. Further, the control of the switch nodes can be swapped between the internal and external MOSFETs as a result of being able to dither both internal and external MOSFETs. Also, the embodiments described herein can provide flexibility by using one or more of the controller 112 and AFE 150 to perform the different control schemes. This flexibility can allow the different control schemes to be performed by a single IC. One or more of the control schemes described herein can save PWM pins delays in the AFE 150 written by controller 112 and fewer PWM signals are needed. For smaller AFEs, more PWM signals can be used and the controller 112 can perform the calculations and dithering based upon data extracted from the AFE 150.

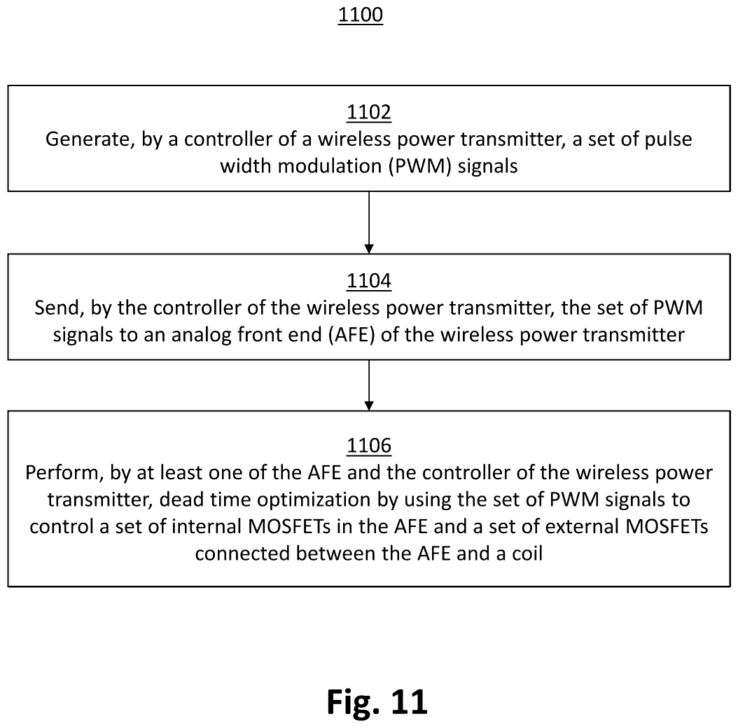

FIG. 11 is a flow diagram illustrating another process to implement internal and external devices control in wireless power systems in one embodiment. A process 1100 can include one or more operations, actions, or functions as illustrated by one or more of blocks 1102, 1104, 1106 and/or 1108. Although illustrated as discrete blocks, various blocks can be divided into additional blocks, combined into fewer blocks, eliminated, performed in different order, or performed in parallel, depending on the desired implementation.

Process 1100 can be performed by a wireless power transmitter, such as transmitter 110 described herein. Process 1100 can being at block 1102. At block 1102, a controller of a wireless power transmitter can generate a set of pulse width modulation (PWM) signals.

Process 1100 can proceed from block 1102 to block 1104. At block 1104, the controller of the wireless power transmitter can send the set of PWM signals to an analog front end (AFE) of the wireless power transmitter.

Process 1100 can proceed from block 1104 to block 1106. At block 1106, at least one of the AFE and the controller of the wireless power transmitter can perform dead time optimization by using the set of PWM signals to control a set of internal MOSFETs in the AFE and a set of external MOSFETs connected between the AFE and a coil.

In one embodiment, performing the dead time optimization can include programming, by the AFE of the wireless power transmitter, an ON time duration of the set of external MOSFETs to a fixed value. The AFE can further apply zero voltage switching on the set of internal MOSFETs.

In one embodiment, performing the dead time optimization can include delaying, by the AFE of the wireless power transmitter, a turn on time of the set of external MOSFETs by fixed value to cause the set of external MOSFETs to turn on after the set of internal MOSFETs are turned. The AFE can further turn off the set of external MOSFETs at the same time as falling edge of the set of PWM signals to cause the set of external MOSFETs to turn off before the set of internal MOSFETs. The AFE can further apply zero voltage switching on the set of internal MOSFETs.

In one embodiment, performing the dead time optimization can include using, by the controller of the wireless power transmitter, the set of PWM signals to control the set of external MOSFETs to turn on after the set of internal MOSFETs are turned on and to turn off before the set of internal MOSFETs turn off. The AFE can further apply zero voltage switching on the set of internal MOSFETs.

In one embodiment, performing the dead time optimization can include operating, by the AFE of the wireless power transmitter, the set of internal MOSFETs using at least one of the set of PWM signals provide by the controller. The AFE can further determine first characteristics of the set of internal MOSFETs. The AFE can further operate the set of internal MOSFETs and the set of external MOSFETs using at least one of the set of PWM signals provided by the controller. The AFE can further determine second characteristics of the set of external MOSFETs. The AFE can further, based on the first and second characteristics, perform dithering on one of the set of internal MOSFETs and the set of external MOSFETs.

In one embodiment, performing the dead time optimization can include operating, by the controller of the wireless power transmitter, the set of internal MOSFETs using at least one of the set of PWM signals. The controller can further determine first characteristics of the set of internal MOSFETs. The controller can further operate the set of internal MOSFETs and the set of external MOSFETs using at least one of the set of PWM signals. The controller can further determine second characteristics of the set of external MOSFETs. The controller can further, based on the first and second characteristics, perform dithering on one of the set of internal MOSFETs and the set of external MOSFETs.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. An integrated circuit comprising:
an analog front end (AFE) including a set of internal metal-oxide-semiconductor field-effect transistors (MOSFETs); and
a controller configured to:
generate a set of pulse width modulation (PWM) signals; and
send the set of PWM signals to the AFE,
wherein at least one of the AFE and the controller is configured to perform dead time optimization by using the set of PWM signals to control the set of internal MOSFETs and a set of external MOSFETs connected to the AFE.

2. The integrated circuit of claim 1, wherein to perform the dead time optimization, the AFE is configured to:
program an ON time duration of the set of external MOSFETs to a fixed value; and
apply zero voltage switching on the set of internal MOSFETs.

3. The integrated circuit of claim 1, wherein to perform the dead time optimization, the AFE is configured to:
delay a turn on time of the set of external MOSFETs by fixed value to cause the set of external MOSFETs to turn on after the set of internal MOSFETs are turned on;
turn off the set of external MOSFETs at the same time as falling edge of the set of PWM signals to cause the set of external MOSFETs to turn off before the set of internal MOSFETs; and
apply zero voltage switching on the set of internal MOSFETs.

4. The integrated circuit of claim 1, wherein to perform the dead time optimization:
the controller is configured to use the set of PWM signals to control the set of external MOSFETs to turn on after the set of internal MOSFETs are turned on and to turn off before the set of internal MOSFETs turn off; and
the AFE is configured to apply zero voltage switching on the set of internal MOSFETs.

5. The integrated circuit of claim 1, wherein to perform the dead time optimization:
the AFE is configured to:
operate the set of internal MOSFETs using at least one of the set of PWM signals provide by the controller;
determine first characteristics of the set of internal MOSFETs;
operate the set of internal MOSFETs and the set of external MOSFETs using at least one of the set of PWM signals provided by the controller;
determine second characteristics of the set of external MOSFETs; and
based on the first and second characteristics, perform dithering on one of the set of internal MOSFETs and the set of external MOSFETs.

6. The integrated circuit of claim 1, wherein to perform the dead time optimization:
the controller is configured to:
operate the set of internal MOSFETs using at least one of the set of PWM signals;
determine first characteristics of the set of internal MOSFETs;
operate the set of internal MOSFETs and the set of external MOSFETs using at least one of the set of PWM signals;
determine second characteristics of the set of external MOSFETs; and
based on the first and second characteristics, perform dithering on one of the set of internal MOSFETs and the set of external MOSFETs.

7. The integrated circuit of claim 1, wherein the AFE, the set of external MOSFETs and the controller are parts of a wireless power transmitter.

8. The integrated circuit of claim 1, wherein:
the set of internal MOSFETs comprises two or more high-side MOSFETs and two or more low-side MOSFETs; and
the set of external MOSFETs comprises two or more high-side MOSFETs and two or more low-side MOSFETs.

9. A wireless power transmitter comprising:
a coil;
an analog front end (AFE) including a set of internal metal-oxide-semiconductor field-effect transistors (MOSFETs); and
a controller configured to:
generate a set of pulse width modulation (PWM) signals; and
send the set of PWM signals to the AFE,
wherein at least one of the AFE and the controller is configured to perform dead time optimization by using the PWM signals to control at least one of the set of internal MOSFETs and a set of external MOSFETs connected between the AFE and the coil, wherein the coil is driven by the set of internal MOSFETs and the set of external MOSFETs.

10. The wireless power transmitter of claim 9, wherein to perform the dead time optimization, the AFE is configured to:
program an ON time duration of the set of external MOSFETs to a fixed value; and
apply zero voltage switching on the set of internal MOSFETs.

11. The wireless power transmitter of claim 9, wherein to perform the dead time optimization, the AFE is configured to:
delay a turn on time of the set of external MOSFETs by fixed value to cause the set of external MOSFETs to turn on after the set of internal MOSFETs are turned on;
turn off the set of external MOSFETs at the same time as falling edge of the set of PWM signals to cause the set of external MOSFETs to turn off before the set of internal MOSFETs; and
apply zero voltage switching on the set of internal MOSFETs.

12. The wireless power transmitter of claim 9, wherein to perform the dead time optimization:
the controller is configured to use the set of PWM signals to control the set of external MOSFETs to turn on after the set of internal MOSFETs are turned on and to turn off before the set of internal MOSFETs turn off; and
the AFE is configured to apply zero voltage switching on the set of internal MOSFETs.

13. The wireless power transmitter of claim 9, wherein to perform the dead time optimization:
the AFE is configured to:
operate the set of internal MOSFETs using at least one of the set of PWM signals provide by the controller;
determine first characteristics of the set of internal MOSFETs;
operate the set of internal MOSFETs and the set of external MOSFETs using at least one of the set of PWM signals provided by the controller;
determine second characteristics of the set of external MOSFETs; and
based on the first and second characteristics, perform dithering on one of the set of internal MOSFETs and the set of external MOSFETs.

14. The wireless power transmitter of claim 9, wherein to perform the dead time optimization:
the controller is configured to:
operate the set of internal MOSFETs using at least one of the set of PWM signals;
determine first characteristics of the set of internal MOSFETs;
operate the set of internal MOSFETs and the set of external MOSFETs using at least one of the set of PWM signals;
determine second characteristics of the set of external MOSFETs; and
based on the first and second characteristics, perform dithering on one of the set of internal MOSFETs and the set of external MOSFETs.

15. A method comprising:
generating, by a controller of a wireless power transmitter, a set of pulse width modulation (PWM) signals;
sending, by the controller of the wireless power transmitter, the set of PWM signals to an analog front end (AFE) of the wireless power transmitter; and
performing, by at least one of the AFE and the controller of the wireless power transmitter, dead time optimization by using the set of PWM signals to control a set of internal MOSFETs in the AFE and a set of external MOSFETs connected between the AFE and a coil.

16. The method of claim 15, wherein performing the dead time optimization comprises:
programming, by the AFE of the wireless power transmitter, an ON time duration of the set of external MOSFETs to a fixed value; and
applying, by the AFE of the wireless power transmitter, zero voltage switching on the set of internal MOSFETs.

17. The method of claim 15, performing the dead time optimization comprises:
delaying, by the AFE of the wireless power transmitter, a turn on time of the set of external MOSFETs by fixed value to cause the set of external MOSFETs to turn on after the set of internal MOSFETs are turned on;
turning off, by the AFE of the wireless power transmitter, the set of external MOSFETs at the same time as falling edge of the set of PWM signals to cause the set of external MOSFETs to turn off before the set of internal MOSFETs; and
applying, by the AFE of the wireless power transmitter, zero voltage switching on the set of internal MOSFETs.

18. The method of claim 15, wherein performing the dead time optimization comprises:
using, by the controller of the wireless power transmitter, the set of PWM signals to control the set of external MOSFETs to turn on after the set of internal MOSFETs are turned on and to turn off before the set of internal MOSFETs turn off; and
applying, by the AFE of the wireless power transmitter, zero voltage switching on the set of internal MOSFETs.

19. The method of claim 15, wherein performing the dead time optimization comprises:
operating, by the AFE of the wireless power transmitter, the set of internal MOSFETs using at least one of the set of PWM signals provide by the controller;
determining, by the AFE of the wireless power transmitter, first characteristics of the set of internal MOSFETs;
operating, by the AFE of the wireless power transmitter, the set of internal MOSFETs and the set of external MOSFETs using at least one of the set of PWM signals provided by the controller;
determining, by the AFE of the wireless power transmitter, second characteristics of the set of external MOSFETs; and
based on the first and second characteristics, performing, by the AFE of the wireless power transmitter, dithering on one of the set of internal MOSFETs and the set of external MOSFETs.

20. The method of claim 15, wherein performing the dead time optimization comprises:
operating, by the controller of the wireless power transmitter, the set of internal MOSFETs using at least one of the set of PWM signals;
determining, by the controller of the wireless power transmitter, first characteristics of the set of internal MOSFETs;
operating, by the controller of the wireless power transmitter, the set of internal MOSFETs and the set of external MOSFETs using at least one of the set of PWM signals;
determining, by the controller of the wireless power transmitter, second characteristics of the set of external MOSFETs; and
based on the first and second characteristics, performing, by the controller of the wireless power transmitter, dithering on one of the set of internal MOSFETs and the set of external MOSFETs.
